(19) United States
(12) Patent Application Publication
(10) Pub. No.: US 2006/0250502 A1
(43) Pub. Date: Nov. 9, 2006

(54) USB camera

(75) Inventor: Robert Tsao, Taipei City (TW)

Correspondence Address: Robert Tsao, 9F., No. 37, Dongsing Road, Xinyi District, Taipei City, 110, TW

(73) Assignee: Good Way Technology Co., Ltd

(21) Appl. No.: 11/121,903

(22) Filed: May 5, 2005

(51) Int. Cl. H04N 5/225

(52) U.S. Cl. 348/207.1

(57) ABSTRACT

The present invention discloses a USB hub and a webcam, wherein the USB hub has at least one USB socket, and one of the USB sockets is installed on a surface of the USB hub. The webcam includes a lens and a support arm downwardly extended from the bottom of the lens, and a USB plug is disposed at a free end of the support arm, such that the webcam can be integrated directly on the surface of the USB hub to provide the webcam several USB sockets for connecting other peripherals.

### FIELD OF THE INVENTION

The present invention relates to a webcam camera directly coupled to the surface of a USB hub to provide the webcam several USB sockets for connecting other peripherals to a USB camera.

### BACKGROUND OF THE INVENTION

At present, a general webcam only comes with an erect base for fixing a lens, and the base or the lens is connected to a transmission line. The transmission line includes a USB plug at its free end, and the USB plug can be inserted into a corresponding socket of a computer system. However, the present multimedia computer usually connects many peripherals, and the quantity of USB sockets provided by a set of computer system is very limited, and thus users usually have to plug and unplug the USB plug of a peripheral in order to use another peripheral, and such arrangement is very inconvenient. In view of the foregoing drawback, related manufacturers have been developing USB hubs to improve the expandability of the USB sockets and provide more USB sockets for users to install the required peripherals. However, none has come up with an integration of a webcam with a USB hub till now. If the webcam and USB hub can be integrated, it definitely will lower the cost and enhance the functions as well as making the product more competitive.

### SUMMARY OF THE INVENTION

In view of the shortcomings of the prior art webcams, the inventor of the present invention based on years of experience in the related industry to conduct researches to overcome the aforementioned shortcomings, and finally invented a webcam that can be integrated directly to the surface of the USB hub to provide the webcam several USB sockets for connecting other peripherals to the USB camera.

Therefore, it is a primary objective of the present invention to provide a webcam that can be integrated directly to the surface of the USB hub to provide the webcam several USB sockets for connecting other peripherals to the USB camera.

To achieve the foregoing objective, a USB camera in accordance with the invention comprises a USB hub and a webcam, wherein the USB hub has at least one USB socket, and one of the USB sockets is installed on a surface of the USB hub. The webcam includes a lens and a support arm downwardly extended from the bottom of the lens, and a USB plug is disposed at a free end of the support arm, such that the webcam can be integrated directly on the surface of the USB hub to provide the webcam several USB sockets or connecting other peripherals.

### BRIEF DESCRIPTION OF THE DRAWINGS

FIG. 1 is an exploded view of a structure of the present invention;

FIG. 2 is a perspective view of a structure of the present invention;

FIG. 3 is a perspective view of another structure of the present invention; and

FIG. 4 shows an application of a preferred embodiment of the present invention.

### DETAILED DESCRIPTION OF THE PREFERRED EMBODIMENTS

To make it easier for our examiner to understand the objective of the invention, its innovative features and performance, a detailed description and technical characteristics of the present invention are described together with the drawings as follows.

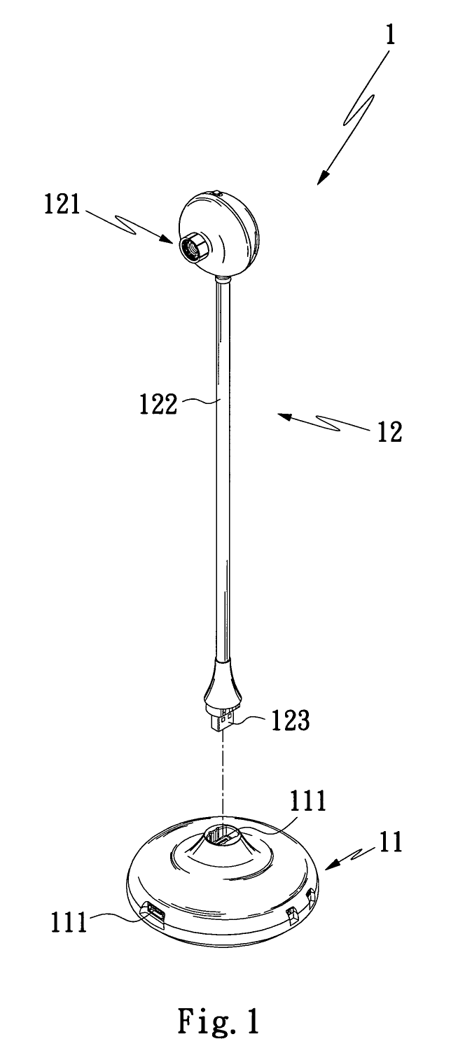

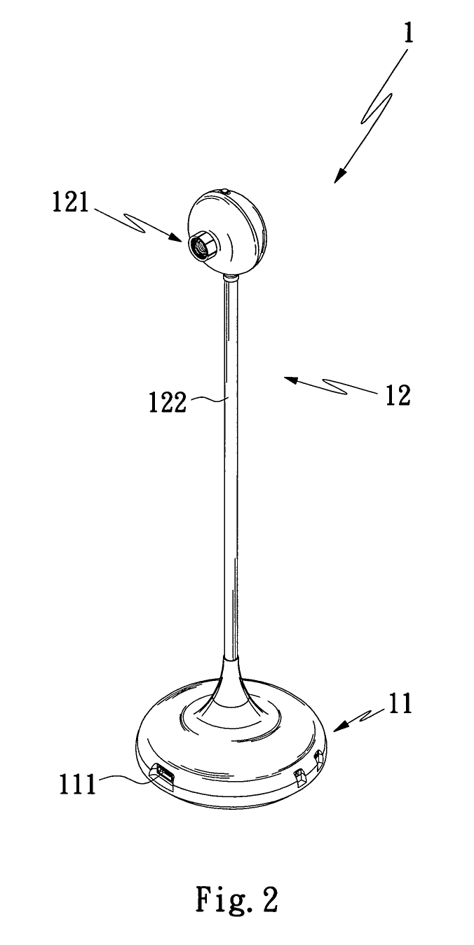

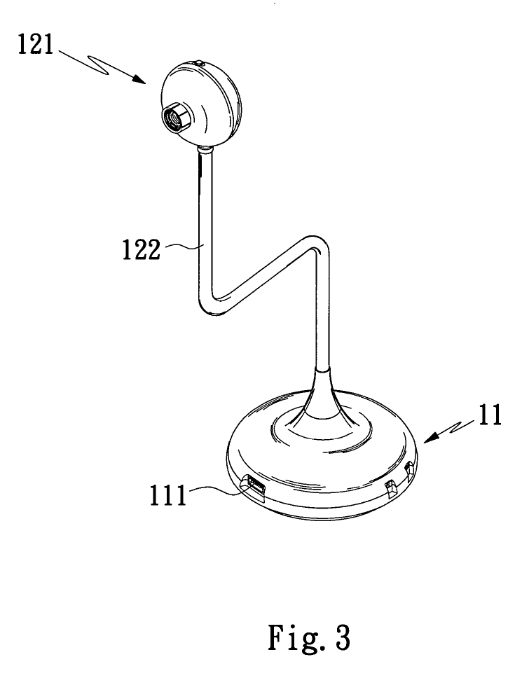

Referring to FIGS. 1 to 3 for the exploded view, perspective view and another perspective view of the structure of the present invention respectively, the USB camera 1 comprises a USB hub 11 and a webcam 12, wherein the USB hub 11 has a conical shape at the center of its surface, a disc-shape periphery and at least one USB socket 111, and one of the USB sockets 111 is installed at the conical top surface of the USB hub 11. The webcam 23 has a spherical lens 121, a support arm 122 downwardly extended from the bottom of the lens 121, a flexible metal disposed in the support arm 122 (which can be a bent support arm as shown in FIG. 3), and a USB plug disposed at a free end of the support arm 122.

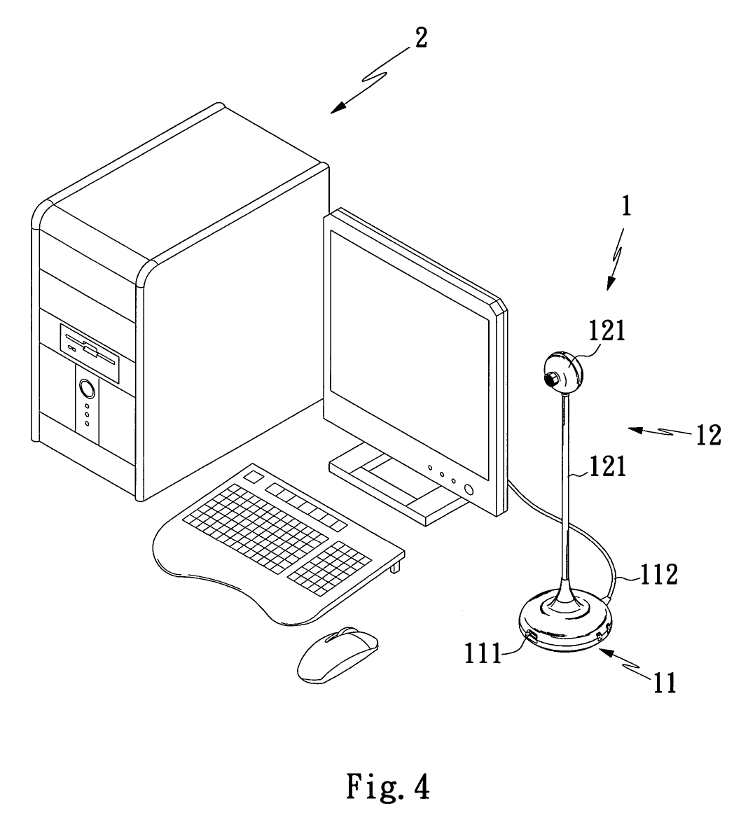

Referring to FIG. 4 for the structural design according to a preferred embodiment of the present invention, the USB camera 1 uses a transmission line 112 to connect a USB socket 111 of the USB hub and a USB socket (not shown in the figure) of a computer system 2, so as to provide the webcam several USB sockets for connecting other peripherals.

In summation of the above description, the design of the USB camera in accordance with the present invention enhances the performance over the conventional structure and further complies with the patent application requirements and is submitted to the Patent and Trademark Office for review and granting of the commensurate patent rights.

What is claimed is:

1. A USB camera, comprising:
a USB hub, having at least one USB socket and said one USB socket being disposed on a surface of said USB hub; and
a webcam, having a lens, a support arm downwardly extended from the bottom of said lens, and a USB plug disposed at a free end of said support arm.

2. The USB camera of claim 1, wherein said USB hub is substantially disc-shaped with a conical shape at the center of a surface of said USB hub and has a conical top installed at said USB socket.

3. The USB camera of claim 1, wherein said lens is substantially in a spherical shape.

4. The USB camera of claim 1, wherein said support arm includes a flexible metal disposed therein.
